(19) United States
(12) Patent Application Publication
(10) Pub. No.: US 2011/0201356 A1
(43) Pub. Date: Aug. 18, 2011

(54) SYSTEM AND METHOD FOR PROVIDING LOCATION DATA TO MOBILE DEVICES

(75) Inventor: Moses Lynn George, San Jose, CA (US)

(73) Assignee: Palm, Inc.

(21) Appl. No.: 12/708,372

(22) Filed: Feb. 18, 2010

(51) Int. Cl. H04W 24/00; H04M 1/00

(52) U.S. Cl. 455/456.2; 455/566

(57) ABSTRACT

A mobile computing device includes a housing, a display disposed in the housing, and a processing circuit disposed in the housing and coupled to the display, the processing circuit being configured to initiate a wireless telephone communication with a second mobile device, and wirelessly transmit a current location of the mobile computing device to at least one server based at least in part on initiation of the wireless telephone communication.

### BACKGROUND

The present application relates generally to mobile devices, and more particularly, to systems and methods for providing location data to users of mobile devices during wireless communications between users.

Conventional mobile devices may provide information to users in the form of, for example, a name, a phone number, one or more status indicators (e.g., icons) provided as part of a display, etc. during, for example, a wireless telephone communication established using a mobile device.

The embodiments herein may provide an improved system and method for providing location data to users of mobile devices in connection with wireless telephone communications between users.

### BRIEF DESCRIPTION OF THE DRAWINGS

FIG. 1 is a perspective view of a mobile computing device according to an exemplary embodiment.

FIG. 2 is a front view of the mobile computing device of FIG. 1 in an extended configuration according to an exemplary embodiment.

FIG. 3 is a back view of the mobile computing device of FIG. 1 in an extended configuration according to an exemplary embodiment.

FIG. 4 is a side view of the mobile computing device of FIG. 1 in an extended configuration according to an exemplary embodiment

FIG. 5 is a block diagram of the mobile computing device of FIG. 1 according to an exemplary embodiment.

FIG. 6 is an illustration of a mobile computing device and an associated network environment according to an exemplary embodiment.

FIG. 7 is a flow chart illustrating a method for providing location data to mobile computing devices according to an exemplary embodiment.

FIG. 8 is an illustration of a display for a mobile computing device according to an exemplary embodiment.

### DETAILED DESCRIPTION OF EXEMPLARY EMBODIMENTS

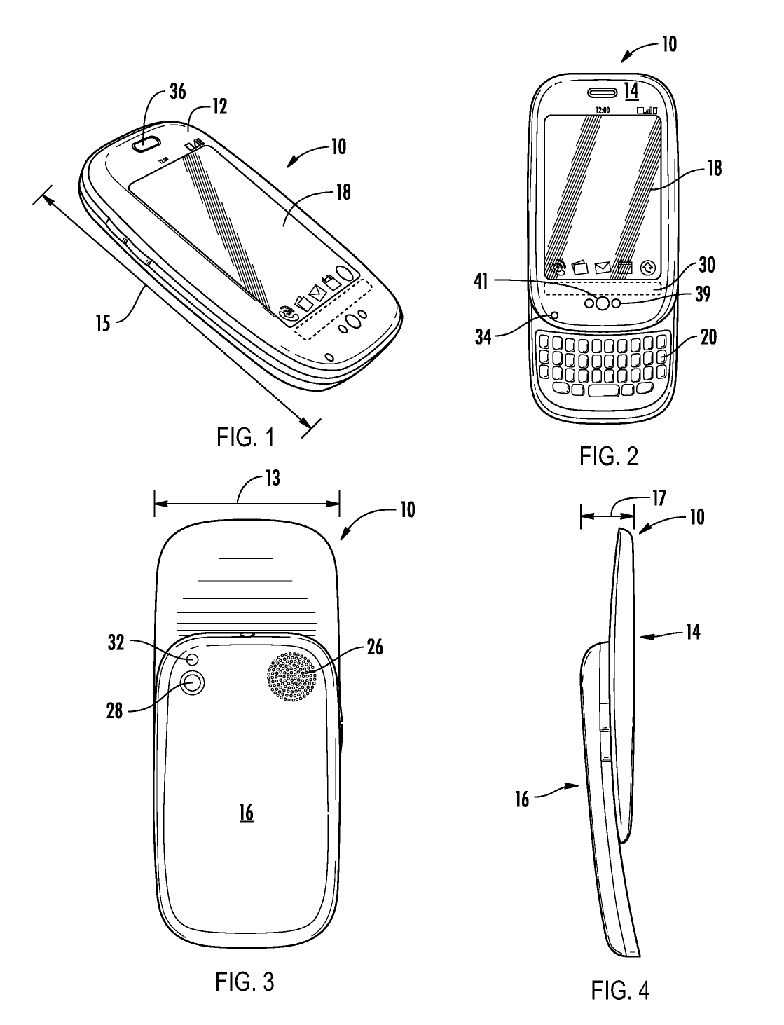

Referring to FIGS. 1-4, a mobile device 10 is shown. The teachings herein can be applied to device 10 or to other electronic devices (e.g., a desktop computer), mobile computing devices (e.g., a laptop computer) or handheld computing devices, such as a personal digital assistant (PDA), smartphone, mobile telephone, personal navigation device, etc. According to one embodiment, device 10 may be a smartphone, which is a combination mobile telephone and handheld computer having PDA functionality. PDA functionality can comprise one or more of personal information management (e.g., including personal data applications such as email, calendar, contacts, etc.), database functions, word processing, spreadsheets, voice memo recording, Global Positioning System (GPS) functionality, etc. Device 10 may be configured to synchronize personal information from these applications with a computer (e.g., a desktop, laptop, server, etc.). Device 10 may be further configured to receive and operate additional applications provided to device 10 after manufacture, e.g., via wired or wireless download, SecureDigital card, etc.

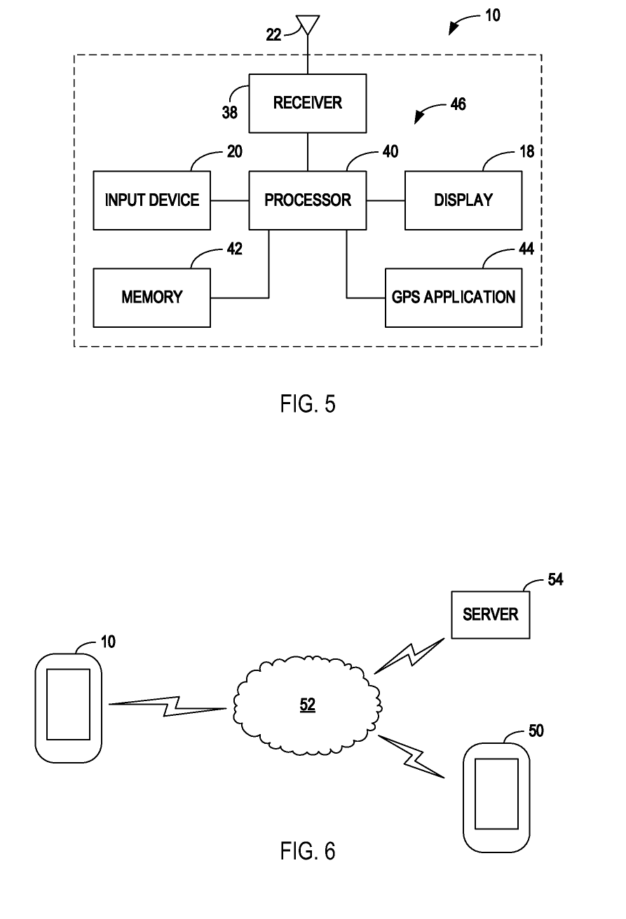

As shown in FIGS. 1-4, device 10 includes a housing 12 and a front 14 and a back 16. Device 10 further comprises a display 18 and a user input device 20 (e.g., an alphanumeric or QWERTY keyboard, buttons, touch screen, speech recognition engine, etc.). Display 18 may comprise a touch screen display in order to provide user input to a processing circuit 46 (see FIG. 5) to control functions, such as to select options displayed on display 18, enter text input to device 10, or enter other types of input. Display 18 also provides images (see, e.g., FIG. 8) that are displayed and may be viewed by users of device 10. User input device 20 can provide similar inputs as those of touch screen display 18. An input button 41 may be provided on front 14 and may be configured to perform pre-programmed functions. Device 10 can further comprise a speaker 26, a stylus (not shown) to assist the user in making selections on display 18, a camera 28, a camera flash 32, a microphone 34, and an earpiece 36.

Display 18 may comprise a capacitive touch screen, a mutual capacitance touch screen, a self capacitance touch screen, a resistive touch screen, a touch screen using cameras and light such as a surface multi-touch screen, proximity sensors, or other touch screen technologies, and so on. Display 18 may be configured to receive inputs from finger touches at a plurality of locations on display 18 at the same time. Display 18 may be configured to receive a finger swipe or other directional input, which may be interpreted by a processing circuit to control certain functions distinct from a single touch input. Further, a gesture area 30 may be provided adjacent to (e.g., below, above, to a side, etc.) or be incorporated into display 18 to receive various gestures as inputs, including taps, swipes, drags, flips, pinches, and so on. One or more indicator areas 39 (e.g., lights, etc.) may be provided to indicate that a gesture has been received from a user.

According to an exemplary embodiment, housing 12 is configured to hold a screen such as display 18 in a fixed relationship above a user input device such as user input device 20 in a substantially parallel or same plane. This fixed relationship excludes a hinged or movable relationship between the screen and the user input device (e.g., a plurality of keys) in the fixed embodiment.

Device 10 may be a handheld computer, which is a computer small enough to be carried in a hand of a user, comprising such devices as typical mobile telephones and personal digital assistants, but excluding typical laptop computers and tablet PCs. The various input devices and other components of device 10 as described below may be positioned anywhere on device 10 (e.g., the front surface shown in FIG. 2, the rear surface shown in FIG. 3, the side surfaces as shown in FIG. 4, etc.). Furthermore, various components such as a keyboard etc. may be retractable to slide in and out from a portion of device 10 to be revealed along any of the sides of device 10, etc. For example, as shown in FIGS. 2-4, front 14 may be slidably adjustable relative to back 16 to reveal input device 20, such that in a retracted configuration (see FIG. 1) input device 20 is not visible, and in an extended configuration (see FIGS. 2-4) input device 20 is visible.

According to various exemplary embodiments, housing 12 may be any size, shape, and have a variety of length, width, thickness, and volume dimensions. For example, width 13 may be no more than about 200 millimeters (mm), 100 mm, 85 mm, or 65 mm, or alternatively, at least about 30 mm, 50 mm, or 55 mm. Length 15 may be no more than about 200 mm, 150 mm, 135 mm, or 125 mm, or alternatively, at least about 70 mm or 100 mm. Thickness 17 may be no more than about 150 mm, 50 mm, 25 mm, or 15 mm, or alternatively, at least about 10 mm, 15 mm, or 50 mm. The volume of housing 12 may be no more than about 2500 cubic centimeters (cc) or 1500 cc, or alternatively, at least about 1000 cc or 600 cc.

Device 10 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, third generation (3G) systems such as Wide-Band CDMA (WCDMA), or other cellular radio telephone technologies, etc.

In addition to voice communications functionality, device 10 may be configured to provide data communications functionality in accordance with different types of cellular radiotelephone systems. Examples of cellular radiotelephone systems offering data communications services may include GSM with General Packet Radio Service (GPRS) systems (GSM/GPRS), CDMA/1×RTT systems, Enhanced Data Rates for Global Evolution (EDGE) systems, Evolution Data Only or Evolution Data Optimized (EV-DO) systems, Long Term Evolution (LTE) systems, etc.

Device 10 may be configured to provide voice and/or data communications functionality in accordance with different types of wireless network systems. Examples of wireless network systems may further include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

Device 10 may be configured to perform data communications in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth.

Referring now to FIG. 5, device 10 comprises a processing circuit 46 comprising a processor 40. Processor 40 can comprise one or more microprocessors, microcontrollers, and other analog and/or digital circuit components configured to perform the functions described herein. Processor 40 comprises or is coupled to one or more memories such as memory 42 (e.g., random access memory, read only memory, flash, etc.) configured to store software applications provided during manufacture or subsequent to manufacture by the user or by a distributor of device 10. In one embodiment, processor 40 can comprise a first applications microprocessor configured to run a variety of personal information management applications, such as email, a calendar, contacts, etc., and a second, radio processor on a separate chip or as part of a dual-core chip with the application processor. The radio processor is configured to operate telephony functionality.

Device 10 comprises a receiver 38 which comprises analog and/or digital electrical components configured to receive and transmit wireless signals via antenna 22 to provide cellular telephone and/or data communications with a fixed wireless access point, such as a cellular telephone tower, in conjunction with a network carrier, such as, Verizon Wireless, Sprint, etc. Device 10 can further comprise circuitry to provide communication over a local area network, such as Ethernet or according to an IEEE 802.11x standard or a personal area network, such as a Bluetooth or infrared communication technology.

Device 10 further comprises a microphone 36 (see FIG. 2) configured to receive audio signals, such as voice signals, from a user or other person in the vicinity of device 10, typically by way of spoken words. Alternatively or in addition, processor 40 can further be configured to provide video conferencing capabilities by displaying on display 18 video from a remote participant to a video conference, by providing a video camera on device 10 for providing images to the remote participant, by providing text messaging, two-way audio streaming in full- and/or half-duplex mode, etc.

Device 10 further comprises a location determining application, shown in FIG. 3 as GPS application 44. GPS application 44 can communicate with and provide the location of device 10 at any given time. Device 10 may employ one or more location determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 10 may be arranged to operate in one or more location determination modes including, for example, a standalone mode, a mobile station (MS) assisted mode, and/or an MS-based mode. In a standalone mode, such as a standalone GPS mode, device 10 may be arranged to autonomously determine its location without real-time network interaction or support. When operating in an MS-assisted mode or an MS-based mode, however, device 10 may be arranged to communicate over a radio access network (e.g., UMTS radio access network) with a location determination entity such as a location proxy server (LPS) and/or a mobile positioning center (MPC).

Referring now to FIG. 6, device 10 is configured to communicate wirelessly with one or more other devices 50 (e.g., a mobile device, cellular phone, PDA, etc.) and/or a server 54 (e.g., one or more remotely located computer systems or servers, etc.) via network 52 (e.g., a wired or wireless communications network). Network 52 may include any of a variety of wired and/or wireless networks, including cellular, Wifi, Bluetooth, and the like. For example, according to some embodiments, device 10 may communicate with device 50 utilizing a cellular communication network (e.g., a first communication protocol), and device 10 may communicate with server 54 via a Wifi communication network (e.g., a second communication protocol). Various other modes or protocols of communications may be utilized according to various alternative embodiments. Furthermore, while device 50 shown in FIG. 6 may in some embodiments be a mobile device (e.g., cellular phone, smartphone, PDA, etc.), in various other embodiments device 50 may be a laptop computer, a desktop computer, etc.

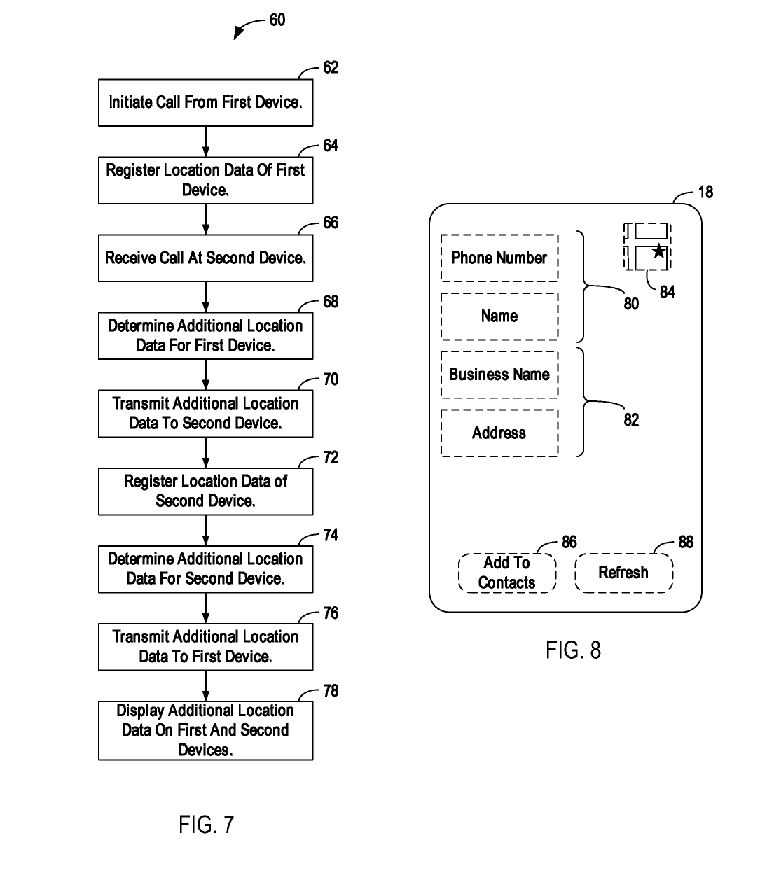

Referring to FIGS. 7-8, device 10 may be configured to provide location data (e.g., a name/business name, a street address, a map image, etc.) to users during phone calls placed or received using device 10. For example, referring to FIG. 7, a method 60 of providing location data to users during a wireless telephone communication is shown according to an exemplary embodiment.

First, in response to a request from a user, a first device 10 initiates a call (step 62), which may be a mobile device such as device 10. In one embodiment, device 10 initiates a cellular telephone communication with a second mobile device such as device 50. Upon initiation of the call, device 10 provides (e.g., registers, etc.) its phone number and location data such as a current location to a server such as server 54 (step 64). Additional or different data may also be provided to server 54. According to one embodiment, rather than device 10 transmitting location data to server 54, server 54 may obtain location data such as a current location of device 10 from a different source, such as another server, etc. In some embodiments, the current location may be determined using a GPS system, such that server 54 receives GPS coordinates from device 10 or another source and stores the location data in, for example, a database. In other embodiments, device 10 and/or server 54 may use any suitable method or technology to determine a current location of device 10.

Upon a second user receiving the call (step 66), for example, at a second device such as device 50, server 54 retrieves the location data (e.g., current location, etc.) for the first device (e.g., by utilizing a “reverse lookup” feature based on the phone number of the first device, or other suitable method) and determines additional location data for the first device (step 68), such as a street address that corresponds to the GPS coordinates of the current location, a personal and/or business name or other point of interest name associated with the current location and/or street address, a map image that indicates the current location of the first device on a street map or other type of map, etc. In some embodiments, the additional location data may be determined by server 54 accessing one or more computer databases to identify the additional location data corresponding to a current location of device 10 (or, similarly, device 50). Server 54 then transmits the additional location data for the first device to the second device (step 70).

Upon the second device receiving the call, the second device provides its phone number and location data such as a current location to a server such as server 54 (step 72). Server 54 is configured to then determine additional location data for the second device (step 74), such as a street address that corresponds with the GPS coordinates of the current location, a personal and/or business name or other point of interest name associated with the current location and/or street address, a map image that indicates the current location of the device on a street map or other type of map, etc. Server 54 then transmits the additional location data for the second device to the first device (step 76).

After receiving the additional location data from server 54, one or both of devices 10, 50 may display the additional location data for the other device during the call (step 78), such that in addition to the information that is typically displayed during a phone call (e.g., a name, phone number, call duration), other information associated with the other party may also be displayed simultaneously, including a street address, a city, state, or other identifier, a map image, a personal and/or business name associated with a location or street address, etc. According to various other embodiments, other information may further be displayed during wireless telephone communications, such as an image (not shown) of a person associated with a phone number, additional data or information from a contacts application, etc.

It should be noted that the various steps shown in FIG. 8 may be resequenced according to various alternative embodiments. For example, in some embodiments, a second device receiving a call from a first device may receive location data (e.g., a street address, business name, map image, etc.) associated with the first device that is displayed when the wireless telephone communication is received (e.g., in a manner similar to a traditional “caller ID” application utilized by many phones). Thus, before even answering the call, the user of the second device is able to view data related to the current location of the caller. Other modifications to the arrangement of the steps shown in FIG. 8 may be made according to various other embodiments. For example, in some embodiments, the location of the remote party may be provided on the caller's device even before the remote party answers the call.

Referring to FIG. 8, display 18 of device 10 is shown with various data displayed during a wireless telephone communication according to an exemplary embodiment. When a phone call is placed or received via device 10 using, for example, a phone application running on processing circuit 46, various data and information may be displayed to a user. For example, the name and phone number 80 of the person to whom the user is speaking may often be displayed (e.g., using conventional caller ID functionality). Further, an image (not shown) of the other party may be provided. In some embodiments, additional location data may be provided on display 18 based on the current location of the other party. For example, a street address and/or personal/business name associated with the street address 82 may be displayed to the user. Further, a map image 84 (e.g., a thumbnail image of a larger depiction of a map, etc.) may be provided that indicates the current location of the user on a street map or other type of map.

It should be noted that while FIG. 7 illustrates displaying additional location data for both parties on the other party's phone, according to various alternative embodiments, additional location data based on current location may be displayed for only one party to the call. In some embodiments, users may be provided with an option to “opt-out” of having their current location utilized, for example, by server 54 for determination of additional location data. For example, a user may be provided with a menu of options that permit a user to configure opt-out preferences, such as location-specific, time of day-specific, caller-specific, or other parameters that may be used to define whether to provide location data for a particular user. Furthermore, the various features disclosed herein may be used with multiple callers (e.g., in connection with a conference call having three or more participants), such that location data associated with the current location of one or more of the participants to the call may be provided to the other participants.

In some embodiments, device 10 may provide the user with the option to save additional location data to a contacts or similar application. For example, if a first user knows that he or she is receiving a call from a second user who is at home, the first user may be provided with the home address of the second user during the call and may save the home address of the second user to a contacts application. Referring to FIG. 8, in some embodiments, an option 86 (“Add to Contacts”) enables a user to easily add data to a contacts application with a single touch (e.g., via a touchscreen).

According to an exemplary embodiment, devices 10, 50 and/or server 54 are configured to periodically (e.g., at regular or irregular intervals, at predetermined intervals, at user-defined intervals, etc.) update the current location of device 10 and/or device 50. Server 54 then may utilize the updated current location to further update the street address, business name, or other information that is transmitted and displayed on devices 10, 50. In this way, if one or more participants to a call are moving during a phone call, the location data displayed for that user may be updated periodically for the other users to view. Referring to FIG. 8, in some embodiments, an option 88 (“Refresh”) may be provided on display 18. Option 88 enables a user to manually request an update of the location data for the other participant(s) to a current phone call.

According to an exemplary embodiment, the additional location data displayed during a phone call on devices 10, 50 may be or comprise one or more selectable links. For example, an address may be or include a selectable link that directs a user to yet additional data, such as textual and/or graphical driving directions to the address from a current location, etc., for example, by launching a mapping program such as Google Maps. The option to provide directions may alternatively be provided in a drop-down menu or via a selectable icon. Further, a thumbnail image may be selectable to direct processing circuit 46 to provide an enlarged or enhanced image of a map or other information or data. Other links may be provided in connection with the additional location data according to various alternative embodiments.

The features disclosed herein may provide many benefits to users with regard to location data of other parties to a phone call. For example, parents may be able to locate children by simply calling a phone in the possession of the children. Similarly, should a person be meeting a friend, the person may place a call to the friend and immediately be provided with a street address, map or similar information indicating the current location of the friend. Furthermore, if a user knows a caller is calling their home or business, the user can easily save their contact information to an appropriate contact entry (e.g., either new or existing) in a contacts application on their mobile device. Various other benefits may be provided by the various components and features discussed herein.

Various embodiments disclosed herein may include or be implemented in connection with computer-readable media (e.g., a non-transmissive or non-transitory computer-readable medium) configured to store machine-executable instructions therein, and/or one or more modules, circuits, units, or other elements that may comprise analog and/or digital circuit components configured or arranged to perform one or more of the steps recited herein. By way of example, computer-readable media may include RAM, ROM, CD-ROM, or other optical disk storage, magnetic disk storage, or any other medium capable of storing and providing access to desired machine-executable instructions.

While the detailed drawings, specific examples, and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the present disclosure as expressed in the appended claims.

What is claimed is:

1. A mobile computing device, comprising:
a housing;
a display disposed in the housing;
a processing circuit disposed in the housing and coupled to the display, the processing circuit configured to
initiate a wireless telephone communication with a second mobile device;
wirelessly transmit a current location of the mobile computing device to at least one server based at least in part on initiation of the wireless telephone communication.

2. The mobile computing device of claim 1, wherein the processing circuit is further configured to receive location data for the second mobile computing device and display the location data for the second mobile computing device on the display during the wireless telephone communication, the location data for the second mobile computing device being determined based at least in part on a current location of the second mobile computing device.

3. The mobile computing device of claim 2, wherein the processing circuit is further configured to save at least a portion of the location data to a contacts application.

4. The mobile computing device of claim 2, wherein the processing circuit is further configured to display a map image that indicates the current location of the second mobile computing device, the map image being displayed during the wireless telephone communication.

5. The mobile computing device of claim 2, wherein the location data comprises a street address and at least one of a personal name and a business name associated with the street address.

6. The mobile computing device of claim 2, wherein the location data includes a selectable link that is configured to direct a user to additional location data, the additional location data including at least one of driving directions and a map image.

7. The mobile computing device of claim 1, wherein the processor is configured to re-transmit the current location of the mobile computing device periodically.

8. The mobile computing device of claim 7, wherein the processor is configured to receive updated location data for the second mobile computing device and display the updated location data during the wireless telephone communication.

9. A computer readable medium comprising computer executable instructions that when executed cause a computer system to:
receive first location data for a first mobile device during a wireless telephone communication between the first mobile device and a second wireless device, the first location data indicating a current location of the first mobile device;
receive second location data for the second mobile device during the wireless telephone communication, the second location data indicating a current location of the first mobile device;
determine additional location data for the first and second mobile devices based at least in part on the first and second location data;
transmit the additional location data for the first mobile device to the second mobile device and transmit the additional location data for the second mobile device to the first mobile device.

10. The computer readable medium of claim 9, wherein the first and second location data comprises GPS location data for the first and second mobile devices and the additional location data for the first and second mobile devices comprises street addresses or points of interest associated with the GPS location date for the first and second mobile devices.

11. The computer readable medium of claim 9, wherein determining the additional location data for the first mobile device comprises accessing a database to identify a street address that corresponds to the current location of the first mobile device.

12. The computer readable medium of claim 9, wherein the computer executable instructions, when executed further cause the computer system to transmit updated additional location data to the first and second mobile devices based at least in part on receiving updated first location data for the first mobile device and updated second location data for the second mobile device.

13. The computer readable medium of claim 9, wherein the additional location data for at least one of the first and second mobile devices comprises one of driving directions and a map image.

14. The computer readable medium of claim 9, wherein the additional location data for the first and second mobile devices is transmitted during the wireless telephone communication.

15. A system for providing location data to mobile devices, the system comprising:
at least one server configured to:
receive location data from a first mobile device, the location data indicating a current location of the first mobile device, the location data being received based at least in part on a wireless telephone communication initiated by the first mobile device;
determine additional location data for the first mobile device based at least in part on the current location; and
transmit the additional location data for the first mobile device to a second mobile device during a wireless telephone communication between the first mobile device and the second mobile device.

16. The system of claim 15, wherein the server is further configured to access a database to identify the additional location data corresponding to the current location.

17. The system of claim 16, wherein the server is further configured to utilize GPS data to identify the additional location data.

18. The system of claim 15, wherein the server is further configured to:
receive second location data for a second mobile device and transmit additional location data for the second mobile device to the first mobile device based at least in part on the second location data.

19. The system of claim 18, wherein the second location data indicates a current location of the second mobile device.

20. The system of claim 15, wherein the server is further configured to periodically transmit updates to the additional location data for the first and second mobile devices based on receiving updated current location data for the first and second mobile devices.
